(19) United States
(12) Patent Application Publication
(10) Pub. No.: US 2020/0117286 A1
(43) Pub. Date: Apr. 16, 2020

(54) CURSOR POSITIONING ADJUSTMENTS

(71) Applicant: Hewlett-Packard Development Company, L.P., Spring, TX (US)

(72) Inventors: Alexander Wayne Clark, Houston, TX (US); Brandon James Lee Haist, Houston, TX (US)

(21) Appl. No.: 16/603,861

(22) PCT Filed: Apr. 7, 2017
(86) PCT No.: PCT/US2017/026628

§ 371 Date: Oct. 9, 2019

(51) Int. Cl. G06F 3/038; G06F 3/01; G06F 3/0354

(52) U.S. Cl. CPC G06F 3/038; G06F 3/013; G06F 2203/0381; G06F 3/03547; G06F 3/03543

(57) ABSTRACT

Example implementations relate adjusting cursor positioning. In some examples, a system may include a cursor positioning device in communication with a computing device. The computing device may be to predict an intended cursor destination based on a detected eye position. The computing device may be to determine a difference between the intended cursor destination and a displayed cursor position resulting from a cursor positioning signal received from the cursor positioning device. The computing device may be to adjust a setting of the computing device to adjust a subsequent cursor positioning signal such that a subsequent displayed cursor position is within a threshold distance from a subsequent intended cursor destination.

### BACKGROUND

A computing device may include a user interface where an interaction between the computing device and a user may occur. For example, a computing device may provide a graphical user interface that allows a user to interact with the computing device operating system and applications through the use of graphical icons and visual indicators. Sensing devices and surfaces may be utilized to translate user touch and user movement into graphical user interface movement and action.

### BRIEF DESCRIPTION OF THE DRAWINGS

FIG. 1 illustrates a diagram of an example of a system to adjust cursor positioning consistent with the disclosure.

FIG. 2 illustrates a diagram of an example of a processing resource and a non-transitory computer readable medium to adjust cursor positioning consistent with the disclosure.

FIG. 3 illustrates a flow diagram of an example of a method for adjusting cursor positioning consistent with the disclosure.

### DETAILED DESCRIPTION

A user may utilize a cursor positioning device to interact with a computing device. As used herein, a cursor positioning device generally refers to a sensing device or sensing surface connected to, in communication with, and/or integrated with a computing device. A cursor positioning device may include a peripheral device and/or an integrated device. For example, a cursor positioning device may include a mouse, a track pad, a handset, a joystick, a light pen, a touchscreen, a trackball, etc.

A cursor positioning device may detect and accept as input user touch and user movement. The cursor positioning device may convert the input into a cursor positioning signal output. As used herein, a cursor positioning signal may include an electronic signal generated by a cursor positioning device to communicate the user touch, user movement, and/or the magnitude of said user touch and user movement.

A computing device may receive the cursor positioning signal as an input. The computing device may respond to the cursor positioning signal. A response to a cursor positioning signal by a computing device may include moving a cursor across a graphical user interface, making a selection of a portion of a graphical user interface, and/or displaying the movement or selection on a display. The response of the computing device to the cursor positioning signal may be based on the cursor positioning signal. That is, a position of a graphical user interface selected and/or a distance traversed across a graphical user interface may be determined based on the cursor position signal.

Different users may have different physical characteristics and different abilities that may influence their interactions with a cursor positioning device. For example, a user may have a unique digit length, unique limb length, unique mobility limitations, unique cognitive abilities, unique reflexes, unique hand-to-eye coordination, a unique range of motion, and/or other unique abilities. The characteristics of a user may influence an interaction with a cursor positioning device by defining the ability of the user to perform manipulations of the cursor positioning device. The characteristics of a user may influence an interaction with a cursor positioning device by defining the response that a user expects to occur (e.g., a portion of a graphical user interface that the user expects to be traversed, a portion of a graphical user interface that the user expects to be selected, etc.) in response to their manipulation of a cursor positioning device. For example, a user with a first range of motion may expect a cursor to traverse a virtual distance of a graphical user interface in response to the user's manipulation of a cursor positioning device by a first physical distance in the natural world. A second user may have a second, more limited, range of motion and may expect a cursor to traverse the same virtual distance in response to the user's manipulation of the same cursor positioning device by a second, more limited, physical distance.

Additionally, different users may have different preferences for a response by a computing device to a cursor positioning signal. A user may prefer a unique relationship between an amount of user input to a cursor positioning device and an amount of a response to the cursor positioning signal. For example, a first user may prefer that a cursor traverses a first virtual distance in response to the user's manipulation of a cursor positioning device by a physical distance in the natural world. Simultaneously, a second user may prefer that the cursor traverses a second, greater, virtual distance in response to the user's manipulation of the cursor manipulation device by the same physical distance. In some examples, user preferences for the response may vary by the user's current body position, an operation the user is engaged in, and/or an application the user is utilizing.

Regardless of whether a user's expectation for a response of a computing device to a cursor positioning signal is based on user characteristics or preference, a user's satisfaction with and efficiency of an interaction with a computing device may be heavily influenced by the ability of the computing device to meet these expectations. A user's ability to seamlessly interface with a graphical user interface may ultimately determine an adoption rate associated with a computing device and/or an operating system of a computing device.

In an attempt to permit users a means of configuring a response of a computing device to a user input, some computing devices allow users to adjust the “speed” of a mouse. The user may navigate a complex web of menus to arrive at a slider that the user may move up or down to adjust the amount of virtual distance traversed by a cursor in response to the same physical manipulation of the mouse. These adjustments are typically limited in granularity and a user may find that several adjustments are needed to achieve even a marginally acceptable, as related to their expectations, alteration of the response to a cursor positioning signal. These adjustments are time consuming and may frustrate many users. For example, a user may make an adjustment and then exit a web of menus and begin to manipulate a graphical user interface only to find that the adjustments were insufficient and the adjustment process will be started all over again. Further, when a user transitions to another device the user will have to go through the adjustments all over again. Further still, when a second user utilizes the same computing device, they may prefer different adjustments.

In contrast, examples of the present disclosure may include systems, methods, and machine-readable media to predict an intended cursor destination based on a detected eye position. The system may determine the difference between the intended cursor destination and a displayed cursor position resulting from a cursor positioning signal received from a cursor positioning device. The system may adjust a setting of the computing device to adjust a subsequent cursor positioning signal such that a subsequent displayed cursor position is within a threshold distance from a subsequent intended cursor destination. That is, examples of the present disclosure may include a system that learns from a user utilizing predictions and actual results to generate a unique user-tailored adjustment to be applied to subsequent cursor positioning signals. The system may provide a fine-tuned and non-intrusive adjustment to a computing device response to a cursor positioning signal that is user specific.

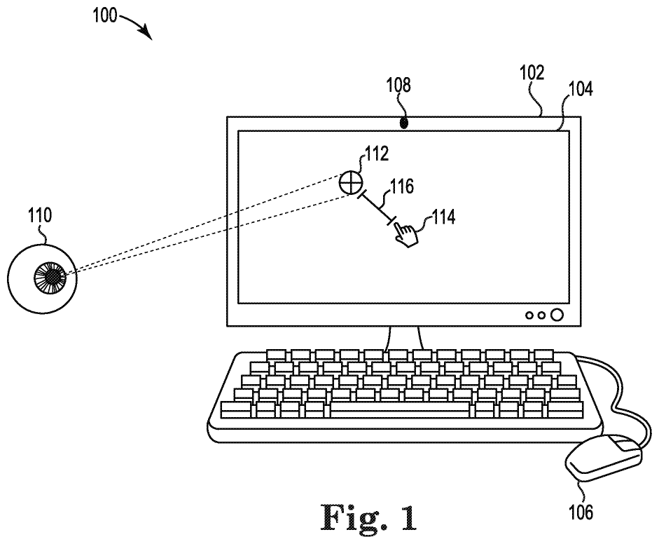

FIG. 1 illustrates an example of a system 100 to adjust cursor positioning consistent with the disclosure. The system 100 may include a computing device 102. As used herein, a computing device 102 may include processing resources and/or machine readable instructions executable by the processing resources. The machine readable instructions may be stored on a memory resource of the computing device 102 such as non-transitory computer readable medium. The machine readable instructions may include instructions for an operating system that manages computing device 102 resources, applications, and services. The machine readable instructions may include instructions to generate and display a graphical user interface (GUI) on a display 104 of the computing device 102. A cursor may be displayed with the GUI on the display 104. The computing device 102 may include a laptop computer, a desktop computer, a tablet computer, a mobile computing device, etc.

The computing device 102 may include and/or be in communication with a cursor positioning device 106. That is, the cursor positioning device 106 may include a peripheral device and/or an integrated device. For example, the cursor positioning device 106 may include a mouse, a track pad, a handset, a joystick, a light pen, a touchscreen, a trackball, etc. The cursor positioning device 106 may be a device from the group consisting of a mouse, a track pad, and a handset.

As described above, the cursor positioning device 106 may detect and accept as input user touch and user movement. The cursor positioning device 106 may convert the input into a cursor positioning signal output. The cursor positioning signal may be utilized by the computing device 102 as the basis for movement across and selection of portions of the GUI.

The computing device 102 may receive the cursor positioning signal from the cursor positioning device 106. The computing device 102 may determine from the cursor positioning signal an action or a movement to effectuate and display in the GUI appearing on the display 104. A distance that a computing device 102 will move and display the movement of a cursor by may be determined based on, for example, an amount of touch or movement input into the cursor positioning device 106. For example, if a user moved their finger across a track pad four inches then the computing device 102 response may include twenty inches of movement of a cursor across a GUI displayed on display 104. In contrast, if a user only moved their finger across a track pad two inches then the computing device 102 response may include ten inches of movement of a cursor across a GUI displayed on display 104.

The computing device 102 may include an eye tracking device 108. An eye tracking device 108 may be integrated with the computing device 102 and/or be in communication with the computing device 102. For example, the eye tracking device 108 may include an optical eye tracking device that utilizes an optical sensor such as a camera to capture light reflected from the eye 110, such as infrared light, to track eye positioning and movement. The eye tracking device 108 may determine a point of gaze of a user's eye 110. As used herein, point of gaze may refer to a location that a user's eye 110 is looking at. A point of gaze may be determined by the eye tracking device 108 by estimating a line of sight (illustrated as hashed lines) of a user's eye 110.

The data collected by the eye tracking device 108 may be utilized to determine an intended cursor destination 112. As used herein, an intended cursor destination 112 may be a location on the GUI appearing on the display 104 that is being targeted as a destination for the cursor. As described above, the location being targeted as a destination for the cursor by a user manipulating a cursor positioning device 106 may be different from where the cursor actually ends up after an execution of a cursor positioning signal received from the manipulated cursor positioning device 106. As such, an actual position of a cursor as displayed on the GUI, hereinafter referred to as a displayed cursor position 114, resulting from the execution of the cursor positioning signal received from the manipulated cursor positioning device 106 may not accurately designate the intended cursor destination 112. Therefore, the eye tracking device 108 may predict the intended cursor destination 112 by identifying a location on a display 104 corresponding to a point of gaze from a determined eye position of a user's eye 110 and identifying the location on the GUI appearing on the identified location on the display 104. The identified location on the GUI may be the intended cursor destination 112.

The eye tracking device 108 may be utilized to predict the intended cursor destination 112 for a particular cursor positioning operation. As used herein, a cursor positioning operation may include a discrete action taken by a user to accomplish a particular operation on the computing device 102. Specific non-limiting examples of a cursor positioning operation may include a user moving a cursor from a first location on a GUI to a second location on a GUI, moving a cursor from a first position on a GUI to an icon on the GUI and selecting the icon, performing a common manipulation of an application not intended for the configuration of peripherals utilizing the GUI, etc. The computing device 102 may identify a discrete cursor positioning operation. For example, the computing device 102 may identify that a cursor is in a resting position. A cursor may be in a resting position when the cursor is stationary and the computing device 102 is not actively receiving a cursor positioning signal from a cursor positioning device 106 that the computing device 102 is in communication with. The computing device 102 may determine that a cursor manipulation operation has been instigated upon receiving a cursor positioning signal from the cursor positioning device 106 instructing movement of the cursor. The position where the cursor was resting prior to receiving the cursor positioning signal may be considered a starting point of the cursor positioning operation.

The computing device 102 may determine a displayed cursor position 114 resulting from the execution of the cursor positioning signal by determining the location of the GUI where the cursor came to rest once the cursor positioning signal for the cursor positioning operation was fully executed to its end. The end of the cursor positioning operation may be defined by an interruption of a user manipulation of the signal-sending cursor positioning device 106. That is, an end of a cursor positioning operation may be predicted from a user stopping or pausing his manipulation of the cursor positioning device 106 since this may signal that a user anticipates that they have manipulated the cursor positioning device 106 enough to complete the intended cursor positioning operation.

The computing device 102 may correlate the data collected by the eye tracking device 108 with the cursor positioning signal for the particular cursor positioning operation. The computing device 102 may determine a difference between the intended cursor destination 112 and the displayed cursor position 114 resulting from an execution of a cursor positioning signal received from the cursor positioning device 106. For example, the computing device 102 may determine a difference 116 between the intended cursor destination 112 and the displayed cursor position 114. The difference 116 may be a physical distance between the intended cursor destination 112 and the displayed cursor position 114 as measured relative to the display 104 and/or the GUI as displayed. The difference 116 may be a virtual distance between the intended cursor destination 112 and the displayed cursor position 114 as measured relative to the instantiation of the GUI.

The computing device 102 may also determine a physical distance associated with a manipulation of the cursor positioning device 106. For example, the computing device 102 may determine a physical distance traversed or by the cursor positioning device 106 during a cursor positioning operation. The computing device 102 may determine a characteristic of a cursor positioning signal received from the cursor positioning device 106. For example, the computing device 102 may determine an impulse, length, magnitude or other physical characteristic of a cursor positioning signal received from the cursor positioning device.

The computing device 102 may determine an adjustment to a setting of the computing device 102. The setting of the computing device 102 may be a setting controlling a response of the computing device to a cursor positioning signal received from the cursor positioning device 106. For example, the setting may be a sensitivity setting that controls the magnitude of a response by the computing device 102 to a cursor positioning signal. In an example, a first cursor positioning signal may be generated by moving the cursor positioning device 106. The computing device 102 may execute the first cursor positioning signal to move a cursor displayed on the display 104 a first distance across the GUI displayed on the display 104. Increasing the sensitivity setting may result in the computing device executing the same first cursor positioning signal to move a cursor displayed on the display 104 a second distance, greater than the first distance, across the GUI displayed on the display 104. Alternatively, decreasing the sensitivity setting may result in the computing device executing the same first cursor positioning signal to move a cursor displayed on the display 104 a third distance, less than the first distance, across the GUI displayed on the display 104.

Determining the adjustment to the setting of the computing device 102 may include determining an adjustment to the setting that would have caused the displayed cursor position 114 to align (e.g., be displayed within a threshold distance on the displayed GUI) with the intended cursor destination 112 in the cursor positioning operation from which the displayed cursor position 114 and intended cursor destination 112 were determined. For example, the adjustment to the setting of the computing device 102 may be determined based on the determined difference 116 between the intended cursor destination 112 and the displayed cursor position 114. The adjustment to the setting of the computing device 102 may also be based on the determined physical distance traversed by the cursor positioning device 106 during the cursor positioning operation and/or a characteristic of a cursor positioning signal received from the cursor positioning device 106 during the cursor positioning operation.

Adjusting the setting of the computing device 102 may include applying the adjustment to a subsequent cursor positioning signal received by the computing device 102. As used herein, a subsequent cursor positioning signal may include a cursor positioning signal received by the computing device subsequent to the cursor positioning signal from which the intended cursor destination 112 and the displayed cursor position 114 were determined. In other words, the subsequent cursor positioning signal may include a cursor positioning signal of a second cursor positioning operation that is different from the first cursor positioning operation from which the difference 116 between the intended cursor destination 112 and the displayed cursor position 114 was determined. The subsequent cursor positioning signal may be received from the same cursor positioning device 106 associated with the first cursor positioning operation or from a different cursor positioning device and/or different cursor positioning device type.

The computing device may apply the setting adjustment to adjust a subsequent cursor positioning signal and/or a response thereto such that a subsequent displayed cursor position (resulting from an execution of the subsequent cursor positioning signal) arrives within a threshold distance from a subsequent intended cursor destination with relation to the GUI. For example, the computing device 102 may utilize the eye tracking device 108 to predict the intended cursor destination 112 for a first cursor positioning operation and then determine a difference 116 between the intended cursor destination 112 and the displayed cursor position 114 for the first cursor positioning operation. The computing device 102 may determine that an execution of the first cursor positioning signal associated with the first cursor positioning operation resulted in the cursor overshooting the intended cursor destination 112 by a distance of X since the displayed cursor position 114 was located a distance of X past the intended cursor destination 112 relative to a starting point associated with the first cursor positioning operation.

The computing device 102 may determine based on the distance X and the characteristics of the first cursor positioning signal that this overshoot is a result of a sensitivity setting that is too high by a factor of Y for a user's preference as expressed by the intended cursor destination 112. The computing device 102 may then adjust a sensitivity setting by a factor of Y such that for a second subsequent cursor positioning operation the response to or characteristics of the subsequent cursor positioning signal is reduced by a factor of Y. As a result of the adjustment, the subsequent displayed cursor position may be within a threshold distance from a subsequent intended cursor destination since the response of the computing device 102 to the subsequent cursor positioning signal should be adjusted to more closely correlate to the user's expectations of the computing device's 102 response to their input.

Since persistent and/or constant iterations of the above described prediction, determination, and adjustment may consume a high level of battery power and/or other computational resources (e.g., processing power, memory operations, etc.) the system 100 may be utilized intermittently. For example, the system 100 may restrict the above described prediction, determination, and adjustment to certain periods. For example, the computing device 102 may be configured to conduct prediction, determination, and adjustment when the computing device 102 is running from an external power source such as alternating current supplied from a wall socket, but to discontinue the prediction, determination, and adjustment when running from an internal power supply such as an on-board battery. Additionally, the computing device 102 may be configured to restrict above described prediction, determination, and adjustment to a calibration period triggered by powering on the device, waking the device from a sleep state, logging on to a user profile, etc. In other examples, the computing device 102 may be configured to restrict the above described prediction, determination, and adjustment to a calibration period triggered by a user input requesting calibration. However, in such examples, the computing device 102 may conduct the above described prediction, determination, and adjustment utilizing data from cursor positioning operations occurring in an application that is not intended for the configuration of peripherals utilizing the GUI. For example, the prediction, determination, and adjustment may be based on data collected during normal use of the computing device 102 by the user that has a purpose beyond configuring a peripheral. For example, the prediction, determination, and adjustment may be conducted utilizing data collected during utilization of a word processing program or during manipulation of file objects on a user's desktop GUI.

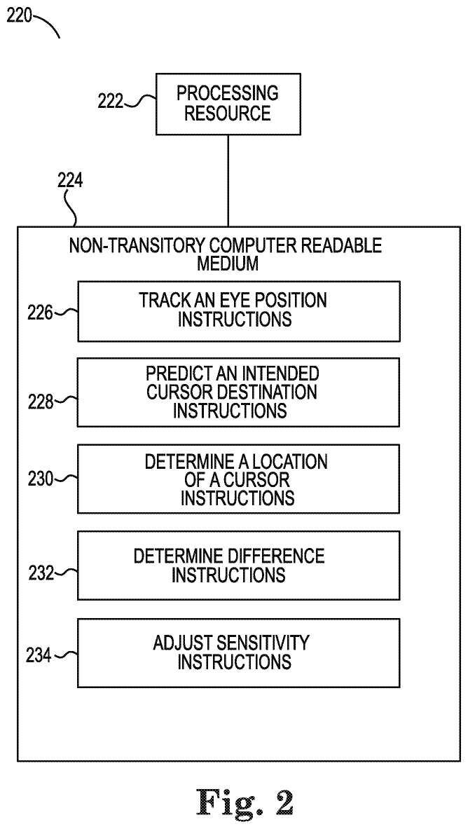

FIG. 2 illustrates a diagram 220 of an example of a processing resource 222 and a non-transitory computer readable medium 224 to adjust cursor positioning consistent with the disclosure. In some examples, the processing resource 222 may process and/or control data received from inputs of an eye tracking device 108 and a cursor positioning device 106 in FIG. 1. A memory resource, such as the non-transitory computer readable medium 224, may be used to store instructions (e.g., 224, 228, 230, 232, 234) executed by the processing resource 222 to perform the operations as described herein, A processing resource 222 may execute the instructions stored on the non-transitory computer readable medium 224. The non-transitory computer readable medium 224 may be any type of volatile or non-volatile memory or storage, such as random access memory (RAM), flash memory, read-only memory (ROM), storage volumes, a hard disk, or a combination thereof.

The example medium 224 may store instructions 226 executable by the processing resource 222 to track an eye position. Tracking the eye position may include utilizing an eye tracking device, such as eye tracking device 108 in FIG. 1, to monitor the position of a user's eye. Tracking the eye position may include identifying a point of gaze on the display and a corresponding location on the GUI being displayed on the display utilizing the tracked eye position. The tracked eye position may be correlated to a discrete cursor positioning operation. For example, an eye position may be tracked with respect to a starting point of a cursor positioning operation through an end point of a cursor positioning operation. As described above, the starting point of the cursor positioning operation may be a location on the GUI where a cursor is resting prior to receiving a cursor positioning signal and the end point may be the location on the GUI that a cursor comes to rest after execution of the cursor positioning signal and prior to any corrective cursor positioning signal is received.

The example medium 224 may store instructions 228 executable by the processing resource 222 to predict an intended cursor destination. The intended cursor destination may be predicted based on the tracked eye position relative to a display. For example, the intended cursor destination may be predicted as the point of gaze of a user's eye on a display as identified through tracking the user's eye position.

The example medium 224 may store instructions 230 executable by the processing resource 222 to determine a location of a cursor on the display. The location of the cursor on the display may be based on a cursor positioning signal received from a cursor positioning device. For example, a cursor positioning device may measure user input and convert the measured input into a corresponding cursor positioning signal. The cursor positioning signal may communicate movement of a cursor relative to a GUI. A location of the cursor on the display may be determined based on the communicated movement of the cursor relative to the GUI.

The example medium 224 may store instructions 232 executable by the processing resource 222 to determine a difference between the intended cursor destination and the location of the cursor on the display. Determining a difference between the intended cursor destination and the location of the cursor on the display may include determining a distance between the intended cursor destination and the location of the cursor. The distance may be a physical distance across a display or GUI, a virtual distance across a display or GUI, a distance measured in pixels, a distance measured in other customary units of length, and/or a distance determined utilizing x-y coordinates corresponding to a GUI.

In addition, determining a difference between the intended cursor destination and the location of the cursor may include determining the difference between the determining the location of the cursor on the display relative to the intended cursor destination and relative to a starting point associated with the cursor positioning signal. For example, a cursor manipulation operation may include a starting point and an ending point as described above. The ending point may be the location of the cursor after execution of the cursor positioning signal. Therefore, determining the difference may include determining a distance between the starting point and the location of the cursor, the distance between the location of the cursor and the intended cursor destination, and/or the distance between the starting point and the location of the cursor. Based on the determined difference, a further determination of whether the location of the cursor fell short of the intended destination or overshot the intended cursor destination may be made. For example, if an intended cursor destination lies between a starting point and a cursor location, or if a distance between a starting point and the cursor location is greater than a distance between a starting point and the intended cursor destination, then it may be determined that the execution of the cursor positioning signal resulted in overshooting the intended cursor destination. In an alternative example, if the cursor location lies between a starting point and an intended cursor destination, or if a distance between a starting point and the cursor location is less than a distance between the starting point and the intended cursor destination, then it may be determined that the execution of the cursor positioning signal resulted in the cursor falling short of the intended cursor destination.

The example medium 224 may store instructions 234 executable by the processing resource 222 to adjust a sensitivity of a response to a subsequent cursor positioning signal based on the determined difference. Adjusting a sensitivity may include adjusting the magnitude of response to a cursor positioning signal. For example, adjusting the sensitivity may include increasing the sensitivity such that an execution of a cursor positioning signal results in a greater distance of cursor travel than the same cursor positioning signal would have generated prior to the adjustment. In another example, adjusting the sensitivity may include decreasing the sensitivity such that an execution of a cursor positioning signal results in a reduced distance of cursor travel than the same cursor positioning signal would have generated prior to the adjustment.

The adjustment to the sensitivity may be based on the determined difference. For instance, adjustment to the sensitivity may be based on the location of the cursor on the display relative to the intended cursor destination and relative to the starting point associated with the cursor positioning signal. For example, adjusting the sensitivity may include increasing the sensitivity when the location of the cursor on the display is located between the intended cursor destination and the starting point. In another example, adjusting the sensitivity may include decreasing the sensitivity when the intended cursor destination is located between the location of the cursor on the display and the starting point.

The adjustment may be applied to a cursor positioning signal received subsequent to the cursor positioning signal upon which the difference and adjustment were determined. The subsequent cursor positioning signal may be a cursor positioning signal that is associated with a different cursor manipulation operation. The subsequent cursor positioning signal may include all cursor positioning signals received after the adjustment and/or all cursor positioning signals received before a second adjustment.

Prior to receiving the subsequent cursor positioning signal, tracking the eye position may be discontinued. In some examples, the subsequent cursor position signal may be a cursor positioning signal received subsequent to discontinuing the tracking of eye position. Discontinuing eye tracking may be performed in order to conserve power and computational resources.

The adjustments to settings such as sensitivity may be added to a settings profile. The settings profile may be compiled and/or stored on a same computing device receiving the cursor positioning signal from which the adjustment was determined or from a separate computing device. The settings profile may be tied to a user profile or user logon. The settings profile may be accessible by a plurality of computing devices. In this manner, a user's sensitivity adjustments may be computing device agnostic and travel with the user obviating recursive calibration procedures across computing devices. For example, the settings profile may be exported to or imported by a computing device and the settings of the computing device may be altered to accord with the adjusted sensitivity. Therefore, regardless of the device a user chooses to utilize, their updated and preferred settings with regard to sensitivity of a response to a cursor positioning signal may be imported without going through a calibration period. The settings profile may also include information to determine appropriate settings for a specific computing device based on the adjustment determined for a different computing device and/or a different model, brand, or type of cursor positioning signal. For example, the settings profile may be utilized to determine that an increase in sensitivity by X for a ball mouse on a first computing device translates to an increase in sensitivity by Y for an optical mouse on a second computing device, where X≠Y.

The settings profile tied to the user profile or user logon may also store information and settings specific to an application that was being utilized during the sensitivity adjustment. For example, the settings profile may store information and settings specific to a word processing application that a cursor manipulation operation was directed to manipulate. In an example, the user profile settings may be application specific and a specific adjustment to a response to a cursor positioning signal may be applied when the corresponding specific application is utilized. A user may have differing preferences or expectations of a device sensitivity setting across various applications. For instance, a user may expect one type of response to a cursor positioning signal when utilizing a word processing application and different type of response to a cursor positioning signal when working on small details while utilizing a design application. To provide appropriate setting adjustments the settings profile can track and include application-specific setting adjustments.

In order to properly apply the application-specific setting adjustments, the instructions 234 may be executable by the processing resource 222 to recognize a specific application and/or application type that is being utilized by a user. Recognizing a specific application may include determining the identity and/or characteristic of an application that is in focus when a cursor positioning signal is received. As used herein, an application is in focus when it is running and it is the component of the GUI that is selected to receive input. For example, if a slide presenting application and a word processing application are running on the GUI and a user begins typing text on a keyboard, then the application interface where the text appears is the application that is in focus. Further, recognizing a specific application may include determining the identity and/or characteristic of an application that is underneath the cursor (starting point, ending point, along a path between a starting point and an ending point, etc.) when a cursor positioning signal is received. The application-specific setting specific to the application that is being utilized by the user may be applied responsive to a recognition of the application.

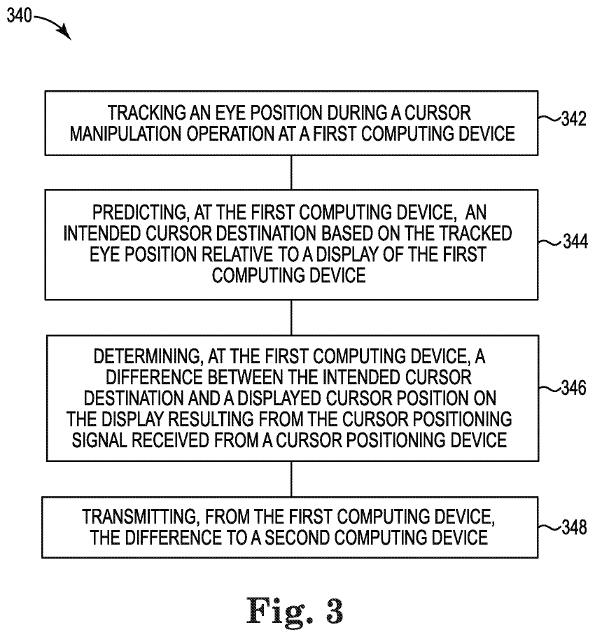

FIG. 3 illustrates a flow diagram of an example of a method 340 for adjusting cursor positioning consistent with the disclosure. At 342, the method 340 may include tracking an eye position during a cursor manipulation operation at a first computing device. Tracking the eye position may be triggered when the first computing device is drawing power from an external power source such as alternating current supplied from a wall socket and/or actively charging an internal power supply such as a battery integrated in the first computing device. Tracking the eye position may be discontinued after a predetermined amount of time, after a predetermined amount of cursor manipulation operations, and/or after the computer is disconnected from the external power source.

At 344, the method 340 may include predicting, at the first computing device, an intended cursor destination. The intended cursor destination may be determined based on the tracked eye position relative to a display of the first computing device. For example, the tracked eye position may be utilized to determine a point of gaze of an eye on the display of the first computing device during the cursor manipulation operation. The point of gaze may be designated as the intended cursor destination for the cursor manipulation operation.

At 346, the method 344 may include determining, at the first computing device, a difference between the intended cursor destination and a displayed cursor position on a display resulting from an execution of a cursor positioning signal received from a cursor positioning device for the cursor manipulation operation. For example, determining the difference may include determining, after an execution of a cursor positioning signal corresponding to a cursor manipulation operation, a distance between the displayed cursor position where the cursor ended up after the execution and the intended cursor destination identified through eye tracking.

At 348, the method 344 may include transmitting, from the first computing device, the difference to a second computing device. The difference may be communicated as a distance between the intended cursor destination and the displayed cursor position, as an adjustment to a sensitivity of a response to a cursor positioning signal determined from the difference, or other data related to the relationship between the intended cursor destination, the displayed cursor position and the cursor manipulation operation. The second computing device may adjust a setting, such as a sensitivity setting, related to a response of the second computing device to a subsequent cursor positioning signal. The adjustment may be based on the difference communicated to the second computing device from the first computing device. Additionally, a family of computing devices may be created. A family of computing devices may include a plurality of computing devices that may include the first computing device, the second computing device, and other computing devices. The family of computing devices may be a variety of different computing device types (e.g., desktop computer, laptop computer, tablet computer, mobile computing device, smartphone, etc.). A sensitivity of a response of each of the plurality of devices of the family to additional subsequent cursor positioning signals may be adjusted based on the difference. In this manner, all of a user's devices may achieve uniform sensitivity adjustments without repeating a calibration process or manual setting adjustment on each device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. A “plurality of” is intended to refer to more than one of such things.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A computing device comprising:
a processing resource; and
a memory resource storing computer-readable instructions to cause the processing resource to:
predict an intended cursor destination based on a detected eye position;
determine a difference between the intended cursor destination and a displayed cursor position resulting from a cursor positioning signal received from a cursor positioning device in communication with the computing device; and
adjust a setting of the computing device to adjust a subsequent cursor positioning signal such that a subsequent displayed cursor position is within a threshold distance from a subsequent intended cursor destination.

2. The computing device of claim 1, wherein the cursor positioning device is a device from a group consisting of a mouse, a track pad, and a handset.

3. The computing device of claim 1, wherein the intended cursor destination corresponds to a target location on a graphical user interface.

4. The computing device of claim 3, wherein the target location on the graphical user interface is identified from a corresponding point of gaze on a display determined from the detected eye position.

5. The computing device of claim 1, wherein to determine a difference between the displayed cursor position and the intended cursor destination includes determining a physical distance between the displayed cursor position and the intended cursor destination.

6. A non-transitory computer-readable medium containing instructions executable by a processing resource to cause the processing resource to:
track an eye position via eye tracking data;
predict an intended cursor destination based on the tracked eye position relative to a display;
determine a location of a cursor on the display based on a cursor positioning signal received from a cursor positioning device;
determine a difference between the intended cursor destination and the location of the cursor on the display; and
adjust a sensitivity of a response to a subsequent cursor positioning signal based on the difference.

7. The non-transitory computer-readable medium of claim 6, further comprising instructions executable to discontinue tracking the eye position prior to receiving the subsequent cursor positioning signal.

8. The non-transitory computer-readable medium of claim 6, wherein determining the difference between the intended cursor destination and the location of the cursor on the display includes determining the location of the cursor on the display relative to the intended cursor destination and a starting point associated with the cursor positioning signal.

9. The non-transitory computer-readable medium of claim 8, wherein adjusting the sensitivity includes increasing the sensitivity when the location of the cursor on the display is located between the intended cursor destination and the starting point.

10. The non-transitory computer-readable medium of claim 8, wherein adjusting the sensitivity includes decreasing the sensitivity when the intended cursor destination is located between the location of the cursor on the display and the starting point.

11. The non-transitory computer-readable medium of claim 6, comprising instructions executable to add the adjusted sensitivity to a settings profile accessible by a plurality of computing devices.

12. A method comprising:
tracking an eye position during a cursor manipulation operation at a first computing device;
predicting, at the first computing device, an intended cursor destination based on the tracked eye position relative to a display of the first computing device;
determining, at the first computing device, a difference between the intended cursor destination and a displayed cursor position on the display, wherein the displayed cursor position is a result of a cursor positioning signal received from a cursor positioning device; and
transmitting, from the first computing device, the difference to a second computing device.

13. The method of claim 12, comprising tracking the eye position during a calibration period triggered when the first computing device is charging.

14. The method of claim 12, comprising adjusting, by the second computing device, a sensitivity of the second computing device to a subsequent cursor positioning signal based on the difference.

15. The method of claim 12, creating a family of computing devices and adjusting, at each of a plurality of computing devices of the family, a sensitivity to additional subsequent cursor positioning signals based on the difference.
